(19) United States
(12) Patent Application Publication
(10) Pub. No.: US 2012/0308829 A1
(43) Pub. Date: Dec. 6, 2012

(54) FLAME-PROTECTED ARTICLE HAVING A HIGH LEVEL OF TRANSMISSION

(75) Inventors: Berit Krauter, Leverkusen (DE); Karlheinz Hildenbrand, Owingen (DE); Frank Buckel, Kempen (DE); Peter Capellen, Krefeld (DE); Ruediger Hahn, Burscheid (DE); Andreas Mueller, Koeln (DE); Constantin Schwecke, Alfter (DE)

(73) Assignee: BAYER INTELLECTUAL PROPERTY GMBH, MONHEIM (DE)

(21) Appl. No.: 13/522,649

(22) PCT Filed: Jan. 19, 2011
(86) PCT No.: PCT/EP11/50647

§ 371 Date: Jul. 17, 2012

(30) Foreign Application Priority Data
Jan. 22, 2010 (DE) 102010005417.8

(51) Int. Cl. B32B 27/06; B05D 5/00

(52) U.S. Cl. 428/412; 428/446; 427/164

(57) ABSTRACT

The invention relates to highly transparent coated articles comprising a substrate (S) of a transparent thermoplastic polymer containing flameproofing agents and, on one side or on both sides, a silica-containing scratch-resistant coating (K) and optionally polyelectrolyte (multi)layers (P) on one or both sides. The invention relates in addition to the production of such coated articles and to their use, in particular in the production of flat display units.

The invention relates to coated articles comprising a substrate (S) of a transparent thermoplastic polymer containing flameproofing agents and, on one side or on both sides, a silica-containing scratch-resistant coating (K) and optionally one or more polyelectrolyte (multi)layers (P). The invention relates in addition to the production of such coated articles and to their use, in particular in the production of flat display units and glazing, and to flat display units and glazing obtainable therefrom.

In the present application, the expression “display unit” describes the front of a monitor containing the so-called screen, that is to say a transparent front plate for showing the image, and optionally a surround of a preferably non-transparent material. In most cases, display units today are flat display units.

The market for flat screen televisions has grown considerably in recent years. The driving force behind this growth, apart from advances in flat screen technology, was in particular the manufacturers' considerable focus on an innovative TV design. Innovative designs could be realised inter alia by the use of plastics as the housing material for the TV set. For example, the increased fitting of black, high-gloss TV front surrounds has been observed in recent years. Preferred housing parts for the use of plastics in recent years were front surrounds and TV backs.

Inside the television, the challenge, inter alia, is to emit as much as possible of the light that is produced forwards through the screen of the TV set. In this respect, increased demands have been made in recent years of the plastics parts inside a TV set.

Simultaneously with the pronounced growth in the flat screen television market, the safety requirements for such TV sets are also increasing. Thus, EN 60065, with reference to CLC/TS 62441, specifies that, from July 2010, flat screen televisions in the European Union must meet minimum standards in respect of the flameproofing of the housing materials that are used. The need for improved flameproofing, combined with high and ever new demands in terms of design, means that new concepts for the production of TV housing parts are required. Thus, one option may be to change the design further by further increasing the use of plastics, for example in the screen, which has hitherto mostly been made of glass, while taking account of material properties such as transparency, transmission and flameproofing. For an economical production process, it is highly valuable to use the same substrate layer for the surround and the screen of the display unit. This means that the material used must meet the demands made of both the surround and the screen, in particular in respect of abrasion resistance, transmission, flame resistance and viscosity.

Uncoated substrates do not satisfactorily meet the demands for use for display units, in particular flat display units, for several reasons. Firstly, the abrasion values, for example with respect to cleaning, are too low and, secondly, the transmission properties, in particular in the range from 550 to 750 nm, are too low. Even in the case of polycarbonate sheets, which are generally distinguished by relatively good transmission properties of about 90% in the visible range, reduced transmission occurs in the wavelength range from 550 to 750 nm in particular in the case of products containing additives, such as, for example, flameproofing agents, UV absorbers or colouring pigments. The addition of conventional flameproofing additives generally has a negative effect on transparency in the case of thermoplastics, that is to say it reduces the transmission. A means of increasing the transmission in the entire range of the visible spectrum would therefore be of considerable interest.

Finally, increased flameproofing properties are required for use, for example, in the electrical or electronics sector (E/E), but such properties can be only inadequately fulfilled by many conventional thermoplastic polymers at low wall thicknesses if a good mechanical property profile is to be obtained at the same time.

In addition, readily flowing thermoplastics which have relatively high MVR values are of particular interest for reasons related to production technology.

In DE 2947 823 A1 and DE 10 2008 020 752 A1, scratch-resistant coatings for polycarbonate substrates are described. Flameproofing agents are not mentioned.

In WO 2008/091131 A1, coating compositions of water glass, SiO₂ and silanes are described as having flameproofing action, but the coated articles of the present application are not described.

US 2006/0100359 and JP 2003-128917 describe coating compositions which have a flameproofing action. Coated articles according to the present application are not described.

Hitherto, the prior art has not offered any solution as to how the property profile as is required, for example, for use both in the surround and in the screen of a display unit can be satisfied in the case of articles that contain only one substrate layer.

Surprisingly, it has now been found that substrates, for example sheets, plates or films, of flameproof transparent thermoplastic plastics, after being provided with silica-containing coatings, exhibit not only outstanding abrasion and scratch resistance but also markedly improved flameproofing properties and transmission properties.

The articles according to the invention, comprising a substrate (S) of a transparent thermoplastic polymer containing flameproofing agents and, on one side or on both sides, a silica-containing scratch-resistant coating (K) and optionally one or more polyelectrolyte layers (P), accordingly represent a solution to the above-described problem that is simple to produce and flexible.

The expression “on one side” means, on the one hand, that one side of the substrate (generally the front) has a silica-containing scratch-resistant coating and, on the other hand, also that one side of the substrate and the edges and side walls of the substrate have the silica-containing scratch-resistant coating.

The expression “on both sides” means, on the one hand, that both sides (upper side and lower side or front and back) of the substrate are coated with a silica-containing scratch-resistant coating and, on the other hand, also that both sides of the substrate and the edges and side walls of the substrate are coated.

The invention relates in addition to the production of such articles and to their use, in particular in the production of flat display units and for glazing, and to the flat display units and glazing obtainable therefrom.

The articles according to the invention are highly transparent. Within the scope of this invention, “highly transparent” means that the coated polymer substrate has a transmission of at least 88%, preferably of at least 90% and most particularly preferably a transmission of from 91% to 96% in the range of the visible spectrum (550 to 750 nm), the transmission being determined according to ASTM E 1348: Standard Test Method for Transmittance and Color by Spectrophotometry Using Hemispherical Geometry, and the thickness of the substrate without a coating being 3 mm.

Within the context of the present invention, the term “silica” denotes wholly or partially crosslinked structures based on silicon dioxide (SiO₂). It includes in particular both sol-gel systems and compositions containing silica nanoparticles.

The substrates (S) are preferably a substrate layer, for example sheets, plates or films or other flat substrates, of transparent thermoplastic polymers that are preferably flame-resistant and/or contain flameproofing agents. The substrate can also consist of a plurality of such substrate layers. The thermoplastic polymers are preferably selected from one or more polymers from the group containing polycarbonates, copolycarbonates (copolymers containing polycarbonate structural units), polyacrylates, in particular polymethyl methacrylate, cycloolefin copolymers, polyesters, in particular polyethylene terephthalate, poly(styrene-co-acrylonitrile) or mixtures of these polymers.

Within the scope of this invention, “transparent” means that the uncoated polymer substrate has a transmission of at least 75%, preferably 80% and most particularly preferably more than 85% in the range of the visible spectrum (550 to 750 nm), the transmission being determined according to ASTM E 1348: Standard Test Method for Transmittance and Color by Spectrophotometry Using Hemispherical Geometry, and the thickness of the substrate without a coating being 3 mm.

There are used as transparent thermoplastic polymers preferably polycarbonate and/or polymethyl methacrylates as well as blends containing at least one of the two thermoplastics. Polycarbonate is particularly preferably used. Polycarbonate is known as a thermoplastically processable plastics material. The polycarbonate plastics are predominantly aromatic polycarbonates based on bisphenols. Linear or branched polycarbonates or mixtures of linear and branched polycarbonates, preferably based on bisphenol A, can be used. The linear or branched polycarbonates and copolycarbonates to be used in the articles according to the invention generally have mean molecular weights M̅w (weight-average) of from 2000 to 200,000 g/mol, preferably from 3000 to 150,000 g/mol, in particular from 5000 to 100,000 g/mol, most particularly preferably from 8000 to 80,000 g/mol, in particular from 12,000 to 70,000 g/mol (determined by means of gel permeation chromatography with polycarbonate calibration).

Within this context they more preferably have mean molecular weights having a weight-average of M̅w of from 16,000 to 40,000 g/mol.

The thermoplastic polymer, in particular polycarbonate, that is used, or the polycarbonate mixture that is used, preferably has an MVR (melt volume rate) greater than or equal to 10 (at 300° C. and 1.2 kg according to ISO 1133), particularly preferably an MVR according to ISO 1133≧20 (at 300° C. and 1.2 kg according to ISO 1133) and most particularly preferably an MVR≧30 (at 300° C. and 1.2 kg according to ISO 1133).

For the preparation of polycarbonates, reference is made, for example, to “Schnell”, Chemistry and Physics of Polycarbonates, Polymer Reviews, Vol. 9, Interscience Publishers, New York, London, Sydney 1964, to D. C. PREVORSEK, B. T. DEBONA and Y. KESTEN, Corporate Research Center, Allied Chemical Corporation, Moristown, N.J. 07960, “Synthesis of Poly(ester) carbonate Copolymers” in Journal of Polymer Science, Polymer Chemistry Edition, Vol. 19, 75-90 (1980), to D. Freitag, U. Grigo, P. R. Müller, N. Nouvertne, BAYER A G, “Polycarbonates” in Encyclopedia of Polymer Science and Engineering, Vol. 11, Second Edition, 1988, pages 648-718 and finally to Dres. U. Grigo, K. Kircher and P. R. Müller “Polycarbonate” in Becker/Braun, Kunststoff-Handbuch, Volume 3/1, Polycarbonate, Polyacetale, Polyester, Celluloseester, Carl Hamer Verlag Munich, Vienna 1992, pages 117-299. The preparation is preferably carried out by the interfacial process or the melt transesterification process.

The polycarbonates are rendered flameproof by the addition of one or more flameproofing additives.

In addition to the flameproofing additives described hereinbelow, the thermoplastic plastics can contain further additives, for example additives conventional for these thermoplastics, such as fillers, UV stabilisers, heat stabilisers, antistatics and pigments in the conventional amounts. The demoulding behaviour and the flow behaviour can optionally be improved by the addition of external demoulding agents and flow agents (e.g. low molecular weight carboxylic acid esters, chalk, quartz flour, glass and carbon fibres, pigments and combinations thereof). Additives conventionally used for polycarbonate are described, for example, in WO 99/55772, p. 15-25, EP 1 308 084 and in the appropriate chapters of the “Plastics Additives Handbook”, ed. Hans Zweifel, 5th Edition 2000, Hanser Publishers, Munich.

The substrates (S) within the scope of the present invention can also comprise a plurality of layers of the above-mentioned thermoplastic plastics.

The thermoplastic substrates can be produced from the thermoplastic plastics by conventional thermoplastic processing methods, for example by means of single-component or multi-component injection moulding processes, extrusion, coextrusion or lamination.

The thickness of the thermoplastic substrates depends on the type of application. For a display unit, a thickness in the range from 1 to 10 mm, preferably from 1 to 5 mm, particularly preferably from 2 to 3 mm, is conventional. In other applications, thicker or thinner substrates are also used. For automotive glazing, substrate thicknesses of about 3 mm are preferably used.

Suitable flameproofing agents within the scope of the present invention are inter alia alkali and alkaline earth salts of aliphatic and aromatic sulfonic acid, sulfonamide and sulfonimide derivatives, for example potassium perfluorobutanesulfonate, potassium diphenyl-sulfonesulfonate, N-(p-tolylsulfonyl)-p-toluenesulfimide potassium salt, N—(N′-benzylaminocarbonyl)-sulfanylimide potassium salt.

Salts which can optionally be used in the moulding compositions according to the invention are, for example: sodium or potassium perfluorobutane sulfate, sodium or potassium perfluoromethanesulfonate, sodium or potassium perfluorooctane sulfate, sodium or potassium 2,5-dichlorobenzene sulfate, sodium or potassium 2,4,5-trichlorobenzene sulfate, sodium or potassium methylphosphonate, sodium or potassium (2-phenyl-ethylene)-phosphonate, sodium or potassium pentachlorobenzoate, sodium or potassium 2,4,6-trichlorobenzoate, sodium or potassium 2,4-dichlorobenzoate, lithium phenyl-phosphonate, sodium or potassium diphenylsulfone-sulfonate, sodium or potassium 2-formyl-benzenesulfonate, sodium or potassium (N-benzenesulfonyl)-benzenesulfonamide, trisodium or tripotassium hexafluoroaluminate, disodium or dipotassium hexafluorotitanate, disodium or dipotassium hexafluorosilicate, disodium or dipotassium hexafluorozirconate, sodium or potassium pyrophosphate, sodium or potassium metaphosphate, sodium or potassium tetrafluoroborate, sodium or potassium hexafluorophosphate, sodium or potassium or lithium phosphate, N-(p-tolylsulfonyl)-p-toluenesulfimide potassium salt, N—(N′-benzylaminocarbonyl)-sulfanylimide potassium salt.

Preference is given to sodium or potassium perfluorobutane sulfate, sodium or potassium perfluoro-octane sulfate, sodium or potassium diphenylsulfone-sulfonate, and sodium or potassium 2,4,6-trichlorobenzoate and N-(p-tolylsulfonyl)-p-toluenesulfimide potassium salt, N—(N′-benzylamino-carbonyl)-sulfanylimide potassium salt. Most particular preference is given to potassium nona-fluoro-1-butanesulfonate and sodium or potassium diphenylsulfonesulfonate. Potassium nona-fluoro-1-butane-sulfonate is available commercially inter alia as Bayowet® C4 (Lanxess, Leverkusen, Germany, CAS-No. 29420-49-3), RM64 (Miteni, Italy) or as 3M™ Perfluorobutanesulfonyl Fluoride FC-51 (3M, USA). Mixtures of the mentioned salts are likewise suitable.

These organic flameproofing salts are used in the moulding compositions in amounts of from 0.01 wt. % to 1.0 wt. %, preferably from 0.01 wt. % to 0.8 wt. %, particularly preferably from 0.01 wt. % to 0.6 wt. %, in each case based on the total composition.

There are suitable as further flameproofing agents, for example, phosphorus-containing flameproofing agents selected from the groups of the monomeric and oligomeric phosphoric and phosphonic acid esters, phosphonate amines, phosphonates, phosphinates, phosphites, hypophosphites, phosphine oxides and phosphazenes, it also being possible to use as flameproofing agents mixtures of a plurality of components selected from one or various of these groups. Other, preferably halogen-free phosphorus compounds not mentioned specifically here can also be used on their own or in any desired combination with other, preferably halogen-free phosphorus compounds. These include also purely inorganic phosphorus compounds such as boron phosphate hydrate. Furthermore, phosphonate amines come into consideration as phosphorus-containing flameproofing agents. The preparation of phosphonate amines is described, for example, in U.S. Pat. No. 5,844,028. Phosphazenes and their preparation are described, for example, in EP-A 728 811 and WO 97/40092. Siloxanes, phosphorylated organosiloxanes, silicones or siloxysilanes can also be used as flameproofing agents, which is described in greater detail, for example, in EP 1 342 753, in DE 10257079A and in EP 1 188 792.

Within the context of the present invention, preference is given to phosphorus compounds of the general formula (4)

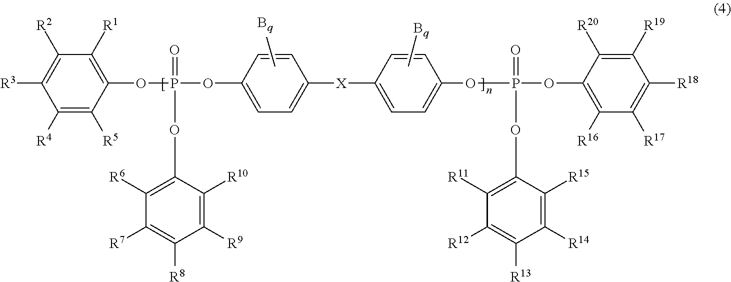

wherein
R¹ to R²⁰ independently of one another denote hydrogen, a linear or branched alkyl group having up to 6 carbon atoms,
n denotes an average value of from 0.5 to 50 and
B in each case denotes C₁-C₁₂-alkyl, preferably methyl, or halogen, preferably chlorine or bromine,
q in each case independently of the other denotes 0, 1 or 2,
X denotes a single bond, C═O, S, O, SO₂, C(CH₃)₂, C₁-C₅-alkylene, C₂-C₅-alkylidene, C₅-C₆-cycloalkylidene, C₆-C₁₂-arylene, to which further aromatic rings optionally containing heteroatoms can be fused, or a radical of formula (5) or (6)

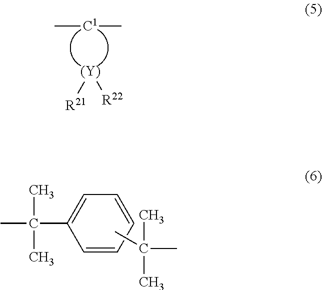

wherein Y denotes carbon and
R²¹ and R²² can be chosen individually for each Y and independently of one another denote hydrogen or C₁-C₆-alkyl, preferably hydrogen, methyl or ethyl,
m denotes an integer from 4 to 7, preferably 4 or 5,
with the proviso that on at least one atom Y, R²¹ and R²² are simultaneously alkyl.

Particular preference is given to phosphorus compounds of formula (4) in which R1 to R20 independently of one another denote hydrogen or a methyl radical and in which q is 0. Particular preference is given to compounds in which X denotes SO₂, O, S, C═O, C₂-C₅-alkylidene, C₅-C₆-cycloalkylidene or C₆-C₁₂-arylene. Compounds wherein X═C(CH₃)₂ are most particularly preferred.

The degree of oligomerisation n is given as the average value from the preparation process for the listed phosphorus-containing compounds. The degree of oligomerisation is generally n<10. Preference is given to compounds wherein n is from 0.5 to 5.0, particularly preferably from 0.7 to 2.5. Most particular preference is given to compounds which contain a high proportion of molecules wherein n=1 of from 60% to 100%, preferably from 70 to 100%, particularly preferably from 79% to 100%. As a result of their preparation, the above compounds may also contain small amounts of triphenyl phosphate. The amounts of this substance are in most cases below 5 wt. %, preference being given in the present context to compounds whose triphenyl phosphate content is in the range from 0 to 5 wt. %, preferably from 0 to 4 wt. %, particularly preferably from 0.0 to 2.5 wt. %, based on the compound of formula (4).

Within the context of the present invention, the phosphorus compounds of formula (4) are used in amounts of from 1 wt. % to 30 wt. %, preferably from 2 wt. % to 20 wt. %, particularly preferably from 2 wt. % to 15 wt. %, in each case based on the total composition.

The mentioned phosphorus compounds are known (see e.g. EP-A 363 608, EP-A 640 655) or can be prepared by known methods in an analogous manner (e.g. Ullmann Encyklopadie der technischen Chemie, Vol. 18, p. 301 ff 1979; Houben-Weyl, Methoden der organischen Chemie, Vol. 12/1, p. 43; Beilstein Vol. 6, p. 177).

Particular preference is given within the context of the present invention to bisphenol A diphosphate. Bisphenol A diphosphate is available commercially inter alia as Reofos® BAPP (Chemtura, Indianapolis, USA), NcendX® P-30 (Albemarle, Baton Rouge, La., USA), Fyrolflex® BDP (Akzo Nobel, Arnheim, Netherlands) or CR 741® (Daihachi, Osaka, Japan).

The preparation of these flameproofing agents is also described, for example, in US-A 2002/0038044.

Further phosphoric acid esters which can be used within the context of the present invention are additionally triphenyl phosphate, which is supplied inter alia as Reofos® TPP (Chemtura), Fyrolflex® TPP (Akzo Nobel) or Disflamoll® TP (Lanxess), and resorcinol diphosphate. Resorcinol diphosphate can be acquired commercially as Reofos RDP (Chemtura) or Fyrolflex® RDP (Akzo Nobel).

Further suitable flameproofing agents within the scope of the present invention are halogen-containing compounds. These include brominated compounds, such as brominated oligocarbonates (e.g. tetrabromobisphenol A oligocarbonate BC-52®, BC-58®, BC-52HP® from Chemtura), polypentabromobenzyl acrylates (e.g. FR 1025 from Dead Sea Bromine (DSB)), oligomeric reaction products of tetrabromobisphenol A with epoxides (e.g. FR 2300 and 2400 from DSB), or brominated oligo- or poly-styrenes (e.g. Pyro-Chek® 68PB from Ferro Corporation, PDBS 80 and Firemaster® PBS-64HW from Chemtura).

Particular preference is given within the context of this invention to brominated oligocarbonates based on bisphenol A, in particular tetrabromobisphenol A oligocarbonate.

Within the context of the present invention, bromine-containing compounds are used in amounts of from 0.1 wt. % to 30.0 wt. %, preferably from 0.1 wt. % to 20.0 wt %, particularly preferably from 0.1 wt. % to 10.0 wt. % and most particularly preferably from 0.1 wt. % to 5.0 wt. %, in each case based on the total composition.

There can also be added to the thermoplastic polymers for the polymer substrates additives conventional for these thermoplastics, such as fillers, UV stabilisers, heat stabilisers, antistatics and pigments in the conventional amounts; the demoulding behaviour, the flow behaviour and/or further properties can optionally also be influenced by the addition of external demoulding agents, flow agents and/or other additives. Compounds suitable as additives are described, for example, in WO 99/55772, p. 15-25, EP 1 308 084 and in the appropriate chapters of the “Plastics Additives Handbook”, ed. Hans Zweifel, 5th Edition 2000, Hanser Publishers, Munich.

Flameproof polycarbonates according to the invention are obtainable commercially, for example, from Bayer MaterialScience, Leverkusen under the name Makrolon® 6557; Makrolon® 6555, or Makrolon® 6485.

The silica-containing scratch-resistant coatings K are coatings obtainable from formulations of a silica-containing scratch-resistant or abrasion-resistant lacquer, for example a silica-containing hybrid lacquer, such as, for example, a siloxane lacquer (sol-gel lacquer), by flood coating, dipping, spraying, roller coating or spin coating.

Hybrid lacquers within the scope of the present invention are based on the use of hybrid polymers as binders. Hybrid polymers (hybrid: lat. “of dual origin”) are polymeric materials which combine structural units of different material classes at the molecular level. As a result of their structure, hybrid polymers can exhibit completely novel property combinations. Unlike composite materials (definite phase boundaries, weak interactions between the phases) and nanocomposites (use of nano-scale fillers), the structural units of hybrid polymers are linked together at the molecular level. This occurs as a result of chemical processes, such as, for example, the sol-gel process, with which inorganic networks can be formed. By the use of organically reactive percursors, for example organically modified metal alkoxides, organic oligomer/polymer structures can additionally be produced. Surface-modified nanoparticle-containing acrylate lacquers, which form an organic/inorganic network after curing, are likewise defined as a hybrid lacquer. There are thermally curable and UV curable hybrid lacquers.

Sol-gel lacquers within the scope of the present invention are silica-containing lacquers which are prepared by the sol-gel process. The sol-gel process is a process for the synthesis of non-metallic inorganic or hybrid-polymeric materials from colloidal dispersions, the so-called sols.

For example, such sol-gel coating solutions can be prepared by hydrolysis of aqueous dispersions of colloidal silicon dioxide and an organoalkoxysilane and/or an alkoxysilane or mixtures of organoalkoxysilanes of the general formula RSi(OR′)₃ and/or alkoxysilanes of the general formula Si(OR′)₄, wherein in the organoalkoxysilane(s) of the general formula RSi(OR′)₃ R represents a monovalent C₁- to C₆-alkyl radical or a wholly or partially fluorinated C₁-C₆-alkyl radical, a vinyl or allyl unit, an aryl radical, or a C₁-C₆-alkoxy group. Particularly preferably, R is a C₁- to C₄-alkyl group, a methyl, ethyl, n-propyl, isopropyl, tert-butyl, sec-butyl or n-butyl group, a vinyl, allyl, phenyl or substituted phenyl unit. The —OR′ are selected independently of one another from the group containing C₁- to C₆-alkoxy groups, a hydroxy group, a formyl unit and an acetyl unit. Some sol-gel polysiloxane lacquers also fall under the definition of a hybrid lacquer.

The colloidal silicon dioxide is obtainable, for example, as e.g. Levasil 200 A (HC Starck), Nalco 1034A (Nalco Chemical Co), Ludox AS-40 or Ludox LS (GRACE Davison). The following compounds may be mentioned as examples of organoalkoxysilanes: 3,3,3-trifluoropropyltrimethoxysilane, methyltrimethoxysilane, methyltrihydroxysilane, methyltriethoxysilane, ethyltrimethoxysilane, methyltriacetoxysilane, ethyltriethoxysilane, phenyltrialkoxysilane (e.g. phenyltriethoxysilane and phenyltrimethoxysilane) and mixtures thereof. The following compounds may be mentioned as examples of alkoxysilanes: tetramethoxysilane and tetraethoxysilane and mixtures thereof.

There can be used as catalysts, for example, organic and/or inorganic acids or bases.

In an embodiment, the colloidal silicon dioxide particles can also be formed in situ by precondensation starting from alkoxysilanes (see in this connection “The Chemistry of Silica”, Ralph K. Iler, John Wiley & Sons, (1979), p. 312-461).

The hydrolysis of the sol-gel solution is terminated or slowed considerably by the addition of solvents, preferably alcoholic solvents such as, for example, isopropanol, n-butanol, isobutanol or mixtures thereof. One or more UV absorbers, which have optionally been pre-dissolved in a solvent, are then added to the sol-gel coating solution, following which an ageing step of several hours or several days/weeks takes place.

Furthermore, further additives and/or stabilisers, such as, for example, flow agents, surface additives, thickeners, pigments, colourings, curing catalysts, IR absorbers and/or adhesion promoters, can be added. The use of hexamethyl-disilazane or comparable compounds, which can lead to reduced susceptibility of the coatings to cracking, is also possible (see also WO 2008/109072 A). The scratch-resistant coating is preferably obtainable from a lacquer or sol-gel lacquer which does not contain polymeric organosiloxanes. Particularly preferred scratch-resistant coatings are produced from the above-mentioned sol-gel coating solutions. Thermal, UV-stabilised, silica-containing sol-gel lacquers are obtainable, for example, from Momentive Performance Materials GmbH under the product names AS4000® and AS4700®.

A possible thermally curable hybrid lacquer is PHC587B® or PHC587C® (Momentive Performance Materials GmbH), see in this connection also EP-A 0 570 165. The layer thickness should be from 1 to 20 μm, preferably from 3 to 16 μm and particularly preferably from 8 to 14 μm.

There can also be used as silica-containing scratch-resistant coatings UV curable, silica nanoparticle-containing acrylate lacquers, as are described in WO 2008/071363 A or DE-A 2804283. A commercially available system is UVHC3000® (Momentive Performance Materials GmbH).

The layer thickness of the scratch-resistant coating is preferably in the range from 1 to 25 μm, particularly preferably from 4 to 16 μm and most particularly preferably from 8 to 15 μm.

The coated articles according to the invention can also be coated with polyelectrolyte (multi)layers (P). The polyelectrolyte layers can comprise a plurality of individual layers (multilayers). These can play an important role in increasing transmission properties. The preparation is carried out as described, for example, in “Current Opinion in Colloid and Interface Science” 8 (2003), p. 86-95, according to the self-assembled principle. The individual components used for the multilayers are cationic polymers, such as, for example, polyallylamine hydrochloride (PAH), polydiallyldimethylammonium chloride (PDADMAC) or polyethyleneimine, and the anionic polymers used are, for example, polystyrenesulfonic acid Na, polyacrylic acid or dextran sulfate. As cited in “Langmuir” 23 (2007), p. 8833-8837 or in Chem. Mater. 19 (2007), p. 1427-1433, it is possible to use as ionic polyelectrolyte components also charged nanoparticles, such as silica nanoparticles with strongly negative zeta potentials or titanium dioxide nanoparticles with strongly positive zeta potentials. Silica-containing polyelectrolyte multilayers applied to glass, in particular, are known to have a transmission-increasing effect, for example from 90% transmission to over 99% transmission. As described in the above-mentioned literature, the thickness of such polyelectrolyte layers, depending on the number of multilayers, is generally of the order of magnitude of approximately from 50 to 200 nm, generally markedly below 1000 nm (1 μm).

Although the polyelectrolyte (PEL) coating, as mentioned, can yield very high transmission values, the scratch resistance of such PEL surfaces is comparatively low. Although the transmission effect of the polyelectrolyte multilayers has hitherto been described only for PEL outer layers, it can surprisingly also be used for the present invention of articles comprising flameproof substrates having silica-containing scratch-resistant outer coatings. To that end, it is possible in an embodiment first to provide the substrates on both sides with the PEL multilayers, which are then provided on one side (on the outside) with a suitable silica-containing scratch-resistant coating.

For the articles according to the invention, particular preference is therefore given to a structure containing polyelectrolyte (multi)layer(s)—substrate—polyelectrolyte (multi)layer(s)—scratch-resistant layer.

As well as having very good scratch resistance on the outside, such systems also exhibit high transmission values of over 94% and are therefore particularly suitable for the use according to the invention in the production of coated articles, in particular display units.

The coated articles according to the invention possess outstanding flameproof properties in combination with increased transmission and very good abrasion resistance. “Rainbow effects” are not to be observed at layer thicknesses greater than 10 μm. In particularly preferred embodiments, the material for the polymer substrates consists of flameproof polycarbonate which has melt viscosity values (melt volume rate MVR in cm³/10 min.)>10 (at 300° C. and 1.2 kg according to ISO 1133), particularly preferably an MVR>20 (at 300° C. and 1.2 kg according to ISO 1133) and most particularly preferably an MVR>30 (at 300° C. and 1.2 kg according to ISO 1133).

Flameproof properties can be determined, for example, by one or more of the following flameproofing tests:

The flame resistance of plastics is commonly determined according to method UL94V Underwriters Laboratories Inc. Standard of Safety, “Test for Flammability of Plastic Materials for Parts in Devices and Appliances”, p. 14 ff, Northbrook 1998; b) J. Troitzsch, “International Plastics Flammability Handbook”, p. 346 ff, Hanser Verlag, Munich 1990) (for further details see 3.2. below). The after-flame times and dripping behaviour of ASTM standard test specimens are thereby evaluated.

In order for a flameproof plastics material to be classified in fire class UL94V-0, the following specific criteria must be fulfilled: in a set of 5 ASTM standard test specimens (dimensions: 127×12.7×X, where X=thickness of the test specimen, e.g. 3.2; 3.0; 1.5; 1.0 or 0.75 mm), none of the specimens may burn for more than 10 seconds after application of an open flame of defined height twice for a period of 10 seconds.

The sum of the after-flame times for 10 flame applications to 5 specimens may not exceed 50 seconds. In addition, there must be no flaming drips, complete combustion or afterglow of the test specimen for longer than 30 seconds. UL94V-1 classification requires that the individual after-flame times do not exceed 30 seconds and that the sum of the after-flame times of 10 flame applications to 5 specimens is not more than 250 seconds. The total afterglow time may not exceed 250 seconds. The remaining criteria are identical with those mentioned above. Classification in fire class UL94V-2 is made if flaming drips occur when the remaining criteria of UL94V-1 classification are met.

The flammability of test specimens can additionally be evaluated by determining the oxygen index (LOI according to ASTM D 2863-77).

A further test of flame resistance is the glow-wire test according to DIN IEC 695-2-1. In this test, the maximum temperature at which an after-flame time of 30 seconds is not exceeded and the specimen does not produce flaming drips is determined on 10 test specimens (for example on sheets measuring 60×60×2 mm or 1 mm) with the aid of a glow wire at temperatures of from 550 to 960° C. This test is particularly valuable in the electrical/electronics field because structural elements in electronic products can attain such high temperatures in the case of faults or overloading that parts in their immediate vicinity can ignite. The glow-wire test simulates such thermal stresses.

In a particular form of the glow-wire test, the glow-wire ignition test according to IEC 60695-1-13, the focus is on the ignition behaviour of the test specimen. In this test, the specimen must not ignite during the test procedure, ignition being defined as the appearance of a flame for longer than 5 seconds. The specimen is not permitted to produce flaming drips.

The articles according to the invention pass one or more of the above-mentioned flameproofing tests and additionally have further advantageous properties, in particular in respect of scratch and abrasion resistance, transmission/transparency and rainbow effects.

The coated articles are highly transparent. In particular, they exhibit a transmission of at least 88%, preferably more than 89% and in most particularly preferred cases more than 89.5% or more than 90% at a wavelength of 550 nm, and a transmission of at least 90%, preferably more than 91% and in most particularly preferred cases more than 91.5% or more than 92% at a wavelength of 700 nm.

In combination with this transparency, the coated articles also exhibit good abrasion resistance as well as increased flame resistance values.

With regard to abrasion resistance, values of less than 15% haze, in particular less than 10% and most particularly less than 5%, are obtained according to the abrasion test (DIN 53 754).

With regard to flame resistance according to standard UL 94 V, at least 70% of the specimens achieve a rating of V1 or better, preferably 80% of the specimens achieve a rating of V1 or better, particularly preferably 90% of the specimens achieve a rating of V1 or better, most particularly preferably 100% of the specimens achieve a rating of V1 or better.

The article according to the invention is accordingly characterised in that it has a transmission, measured according to ASTM E 1348, of at least 88%, preferably more than 89% and in most particularly preferred cases more than 89.5% or more than 90% at a wavelength of 550 nm, and a transmission, measured according to ASTM E 1348, of at least 90%, preferably more than 91% and in most particularly preferred cases more than 91.5% or more than 92% at a wavelength of 700 nm; in the abrasion test, measured according to DIN 53 754, it exhibits values of less than 15% haze, in particular less than 10% and most particularly less than 5%, and in the flame resistance test according to standard UL 94 V it achieves a rating of V1 or better with a probability of 70%, in particular a rating of VI or better with a probability of 80%, particularly preferably a rating of V1 or better with a probability of 90%, most particularly preferably a rating of V1 or better with a probability of 100%.

The articles according to the invention can therefore be used, for example, in the economical production of flat display units, wherein the surround and the screen can optionally be produced in a single injection-moulding process. The invention can additionally also be used for other glazing applications, such as, for example, architectural glazing and automotive glazing.

### EXAMPLES

### A) Substrates

### Example 1

### Preparation of a Flameproof, Readily Flowing Polycarbonate

For the preparation of the composition of Example 1, the following thermoplastic polymers were used:

Makrolon® 2408 is a bisphenol A-based polycarbonate which is available commercially from Bayer MaterialScience AG. Makrolon® 2408 has EU/FDA quality and does not contain UV absorber. The melt volume flow rate (MVR) according to ISO 1133 is 19 cm³/(10 min) at 300° C. and a 1.2 kg load.

Makrolon® LED2245 is a linear bisphenol A-based polycarbonate which is available commercially from Bayer MaterialScience AG. Makrolon® LED2245 has EU/FDA quality and does not contain UV absorber. The melt volume flow rate (MVR) according to ISO 1133 is 35 cm³/(10 min) at 300° C. and a 1.2 kg load.

The following additives were used:

“C4”=Bayowet® C4 is a potassium nona-fluoro-1-butanesulfonate which is available commercially from Lanxess AG.

The flameproof thermoplastic composition according to the present invention is compounded in a device comprising a) a metering device for the components, b) a co-rotating twin-shaft kneader (ZSK 25 from Werner & Pfleiderer) having a screw diameter of 25 mm, c) a perforated die for forming melt extrudates, d) a water bath for cooling and consolidating the extrudates, and a granulator.

The thermoplastic polymer composition for Example 1 was prepared by the metered addition of 10 wt. % of a powder mixture comprising 99.35 wt. % pulverulent Makrolon® 2408 and 0.65 wt. % flameproofing agent C4 to 90 wt. % Makrolon LED® 2245 granulate.

The following process parameters were thereby set:

| Process parameter | |
|---|---|
| Melt temperature | 272° C. |
| Extruder speed | 99 min⁻¹ |
| Turning moment in % | 37-45% |
| Die pressure | 19 bar |
| Die bore | 1 × 4 mm |
| Case temperature case 1: | 54° C. |
| Case temperature case 2: | 220° C. |
| Case temperature case 3: | 240° C. |
| Case temperature case 4: | 260° C. |
| Case temperature case 5: | 260° C. |
| Case temperature case 6: | 260° C. |
| Case temperature case 7: | 260° C. |
| Case temperature case 8: | 260° C. |
| Case temperature head 13: | 260° C. |

A readily flowing bisphenol A polycarbonate having an MVR (300° C./1.2 kg) of 36 cm³/10 min was obtained (measured according to ISO 1133).

### Production of the Substrate Layers

### Example 2

### Sheets of Makrolon® 6555

Sheets of Makrolon® 6555 (bisphenol A polycarbonate from Bayer MaterialScience AG, medium viscosity: MVR (300° C./1.2 kg) 10 cm³/10 min, with chlorine- and bromine-free flameproofing) were produced by processing the granulates indicated hereinbelow in each case to sheet-like test specimens measuring 100*150*2 mm and 100*150*3 mm. This is carried out using an Arburg Allrounder 270S-500-60 with a screw diameter of 18 mm. The following process parameters are set:

| Process parameter | |
|---|---|
| Melt temperature | 300° C. |
| Mould temperature | 90° C. |
| Injection speed | 40 mm/s |
| Dynamic pressure | 150 bar |

### Example 3

### Sheets of the Composition of Example 1

Analogously to Example 2, sheets were produced from the bisphenol A polycarbonate, MVR (300° C./1.2 kg according to ISO 1133) 36 cm³/10 min, with bromine-free flameproofing, of Example 1.

| Process parameter | |
|---|---|
| Melt temperature | 280° C. |
| Mould temperature | 90° C. |
| Injection speed | 40 mm/s |
| Dynamic pressure | 150 bar |

### Example 4

### UL test rods of Makrolon® 6555

Using the same injection-moulding machine (Arburg Allrounder 270S-500-60 with a screw diameter of 18 mm) and the same process parameters as in Example 2, UL test rods of various thicknesses: test rod dimensions: 127 mm*12.7 mm*D mm (D (mm)=3.2/2.6/2.2 and 2.0) of Makrolon® 6555 (bisphenol A polycarbonate from Bayer MaterialScience AG, medium viscosity: MVR (300° C./1.2 kg according to ISO 1133) 10 cm³/10 min, with chlorine- and bromine-free flameproofing) were injection moulded.

The UL test rods are ASTM standard test specimens for UL 94 fire classification.

### Example 5

### UL Test Rods of the Composition of Example 1

Analogously to Example 4, UL test rods were produced from the bisphenol A polycarbonate, MVR (300° C./1.2 kg) 36 cm³/10 min, with bromine-free flameproofing, of Example 1.

### B) Production and Testing of the Coated Articles

### a) Scratch-Resistant Lacquers Used

PHC587® is available commercially from Momentive Performance Materials GmbH, Germany and is a weather-resistant and abrasion-resistant silica-containing scratch-resistant lacquer formulation containing organic constituents having a silica solids content of 20+/−1 wt. % in a solvent mixture of methanol, n-butanol and isopropanol.

The scratch-resistant lacquer can be applied to polycarbonate substrates without an intermediate primer layer. In the examples conducted and described herein, coating was carried out by means of a flooding process as described hereinbelow.

After coating, tempering is carried out for 60 minutes at 110° C. in a hot air oven (curing process).

KASI-PC Flex® is available commercially from KRD Coatings GmbH with a solids content: and is a weather-resistant and abrasion-resistant silica-containing scratch-resistant lacquer formulation, largely analogous to PHC587®, having a solids content of from 18 to 30 wt. % in an isopropyl glycol/methoxypropanol 70:30 solvent mixture.

The scratch-resistant lacquer can likewise be applied to polycarbonate substrates without an intermediate primer layer. In the examples conducted and described herein, coating was carried out by means of a flooding process as described hereinbelow.

After coating, tempering is carried out for 60 minutes at 110° C. in a hot air oven (curing).

SHP 401®/AS 4000® is a commercially available primer formulation/scratch-resistant lacquer system from Momentive Performance Materials GmbH.

AS 4000®, analogously to PHC 587 and KASI-PC Flex, is a silica-containing scratch-resistant lacquer formulation but, unlike PHC or KASI, it does not contain any organic constituents. After coating, curing at 130° C. is required, analogously to PHC 587 or KASI-PC Flex.

SHP 401® is a solvent-containing primer formulation based on polymethyl methacrylate for AS 4000®.

After coating with the primer formulation, the solvent is evaporated off so that the primer layer forms.

UVHC3000® is a commercially available scratch-resistant lacquer system from Momentive Performance Materials GmbH. It is a solvent-based UV-crosslinkable scratch-resistant lacquer formulation containing silica nanoparticles.

After coating, the solvent is evaporated off for 10 minutes at 75° C. and then crosslinking is carried out with UV light at a dose of about 10 J/cm².

### b) Test Methods:

### Layer Thickness:

By means of white light interferometer (ETA SPB-T, ETA-Optik GmbH)

### Adhesion:

The adhesion was determined by means of a cross-cut test according to DIN EN ISO 2409 and subsequent visual assessment of the test specimens. A cross-cut value of 0 means that all the cut edges are completely smooth and none of the cross-cut squares has peeled off. A cross-cut value of 5 means that all the cross-cut squares have peeled off. The values between these two extremes are assigned according to the standard.

### Haze:

The haze is determined according to ASTM D 1003-00 by wide-angle light scattering. The values are given in % haze (H), low values (e.g. 0.5% H) denoting low haze and high transparency.

### Abrasion Test:

The wear resistance (abrasion, DIN 53 754) is determined by means of abrasive wheel methods by the increase in scattered light. A model 5151 Taber abrader with CS-10F Calibrase abrasive wheels (type IV), with an applied weight of 500 g per wheel, was used. The haze values are measured after a specific number of cycles, here 100 or 1000 cycles, low values, for example 0.5% H, denoting good abrasion resistance. Of the order of magnitude, a Δ haze 1000 value of about 2-3 (haze value after 1000 abrasion cycles) denotes outstanding abrasion resistance.

### Pencil Hardness:

The hardness of the lacquer surface is tested according to ASTM 3363 using pencils of different hardnesses, B denoting soft, F firm and H hard.

### Steel Wool Test:

The test was conducted on an “Abraser” test device from Byk Gardner, Rakso grade 00 steel wool being used with an applied weight of 150 g. A total of 20 forward and backward rubs was carried out, the scratching being assessed visually.

### Storage in Water:

The sample is stored for 10 days in water at a temperature of 65+/−2° C., according to ASTM 870-02, the above-mentioned optical and mechanical tests being carried out each day.

### Boiling Test:

The samples are placed in boiling water, the above-mentioned optical and mechanical tests being carried out after 0.5, 1, 2, 3 and 4 hours. If, for example, the 4-hour boiling test is passed without damage, good long-term stability can be predicted.

### Transmission Test:

Device: Perkin Elmer Lamda 900, measurement of total transmission

### Newton's Rings (Rainbow Colours):

Detection is carried out by the white light interferometry method, the substrate being illuminated with a white light source at an angle of 55°. If “rainbow effects” occur owing to variations in layer thickness, these effects can be recorded with a CCD camera.

### Fire Test:

The fire tests are carried out on test rods according to standard UL 94 V, as described in the official Underwriters Laboratories (UL) test process.

The flammability classes are defined as follows:

| | UL 94 flammability class | | | |
|---|---|---|---|---|
| | V-0 | V-1 | V-2 | V n.B. |
| After-flame time after flame | ≦10 | ≦30 | ≦30 | V-2 not |
| application (s) | | | | met |
| Sum of all after-flame times (s) | ≦50 | ≦250 | ≦250 | |
| (10 flame applications) | | | | |
| Flaming and afterglow of the specimens | ≦30 | ≦60 | ≦60 | |
| after the second flame application (s) | | | | |
| Flaming drips (ignition of the cotton wool) | no | no | yes | |
| Complete combustion of the specimen | no | no | no | |

c) Coating of the Substrates with the Scratch-Resistant Lacquers

### Example 6

### Coating of the Sheet of Example 2 on One Side with PHC587® (Flooding)

The substrate was coated by flooding at an angle of 90°, exposed to air for 30 minutes at RT under a hood and then tempered for 60 minutes at 110° C.

Compared with the substrate, the following property changes were achieved by the coating:

| | Example 2 | Example 6 |
|---|---|---|
| Haze (%) | 0.59 | 0.31 |
| ΔHaze 100 (%) | 31.01 | 1.19 |
| ΔHaze 1000 (%) | 40.81 | 2.56 |
| Steel wool test Rakso 00 | considerable scratching | no scratching |
| Pencil hardness PH | 3B | F |
| Transmission % (550 nm) | 88.5 | 89.6 |
| Transmission % (700 nm) | 90.3 | 91.3 |
| Layer thickness (μm) | — | 2.5-5.0 μm |
| Adhesion (boiling test) | — | 4 h: 0 |

As is clear, all the mechanical properties and, surprisingly, also the transmission properties are greatly improved by the coating.

### Example 7

### Coating of the Sheet of Example 2 on Both Sides with PHC587 (Dipping)

The substrate sheet, cut to a size of 104×147×3 mm, was dipped in the lacquer solution for about one second, exposed to air for about 30 minutes at RT and then tempered for 60 minutes at 110° C.

By means of the dipping process there was obtained a scratch-resistant layer comparable, in terms of mechanical properties (abrasion or Maze values, steel wool test and pencil hardness), with the coating applied on one side by the flooding process. It was possible to achieve a further increase in the transmission values by means of the two-sided coating:

| | Example 2 | Example 7 |
|---|---|---|
| Transmission % (550 nm) | 88.5 | 91.3 |
| Transmission % (700 nm) | 90.3 | 94.1 |

### Example 8

### Coating of the Test Rods of Example 4 on Both Sides with PHC 587®

Coating on both sides was carried out by dipping the test rods of Example 4 in the PHC 587® scratch-resistant lacquer solution. The test rods were then exposed to air for 30 minutes at RT and then tempered for 60 minutes at 110° C.

The behaviour in fire was tested according to the UL standard described above. The following table shows the results of the application of flame to a single rod:

| | Number | Number | Number | Number |
|---|---|---|---|---|
| UL 94 @ x mm | V-0 | V-1 | V-2 | V n.B. |
| Example 4 (2.6 mm) | 0 | 0 | 10 | 0 |
| Example 8 (2.6 mm) | 10 | 0 | 0 | 0 |
| Example 4 (2.2 mm) | 0 | 0 | 10 | 0 |
| Example 8 (2.2 mm) | 10 | 0 | 0 | 0 |
| Example 4 (2.0 mm) | 1 | 0 | 19 | 0 |
| Example 8 (2.0 mm) | 12 | 2 | 6 | 0 |

Summary of the fire tests: The results show that the behaviour of the substrate of Example 4 in fire was improved considerably by the coating (Example 8).

Summary of the test as a whole: By means of the coating with PHC587, both the mechanical surface properties (abrasion, pencil hardness) and the optical properties (haze and transmission) were improved considerably. In addition, marked improvements in the behaviour in fire were also achieved.

### Example 9

### Coating of the Sheet of Example 2 on One Side with KASI-PC Flex® (Flooding)

The KASI-PC Flex lacquer was applied to the substrate of Example 2 by flooding at an angle of 90°, whereby the surface was coated. The coated substrate was dried for 45 minutes at RT under a hood and then tempered for 120 minutes at 110° C.

Compared with the substrate, the following properties were determined:

| | Example 2 | Example 9 |
|---|---|---|
| Haze (%) | 0.59 | 0.26 |
| ΔHaze 100 (%) | 31.01 | 4.38 |
| ΔHaze 1000 (%) | 40.81 | 4.39 |
| Steel wool test Rakso 00 | considerable scratching | no scratching |
| Pencil hardness PH | 3B | H |
| Transmission % (550 nm) | 88.5 | 88.9 |
| Transmission % (700 nm) | 90.3 | 91.6 |
| Layer thickness (μm) | — | 2.9-7.3 μm |
| Adhesion (boiling test) | — | 4 h: 0 |

### Example 10

### Coating of the Sheet of Example 2 on Both Sides with KASI-PC Flex (Dipping)

The substrate sheet (Example 2), cut to a size of 104×147×3 mm, was dipped in the lacquer solution for about one second, exposed to air for about 30 minutes at RT and then tempered for 60 minutes at 110° C.

By means of the dipping process there was obtained on both sides a scratch-resistant layer comparable, in terms of mechanical properties (abrasion or ΔHaze values, steel wool test and pencil hardness), with the coating applied on one side by the flooding process (Example 9). It was possible to achieve a further increase in the transmission values by means of the two-sided coating:

| | Example 2 | Example 10 |
|---|---|---|
| Transmission % (550 nm) | 88.5 | 91.0 |
| Transmission % (700 nm) | 90.3 | 93.2 |

### Example 11

### Coating of the Test Rods of Example 4 on Both Sides with KASI-PC Flex® by Dipping (Dipping)

Coating on both sides was carried out by dipping UL test rods of Example 4 having a thickness of 2.6 mm in the lacquer solution. The rods were then exposed to air for 30 minutes at RT and then tempered for 60 minutes at 130° C.

The behaviour in fire was tested according to the UL standard described above. The following table shows the results.

### Behaviour in Fire:

| | Number | Number | Number | Number |
|---|---|---|---|---|
| UL 94 @ 2.6 mm | V-0 | V-1 | V-2 | V n.B. |
| Example 4 | 0 | 0 | 10 | 0 |
| Example 11 | 10 | 0 | 0 | 0 |

### Example 12

### Coating of the Sheet of Example 2 on One Side with SHP 401®/As 4000® (Flooding)

The substrate was coated on one side with the primer lacquer formulation SHP 401® by flooding and exposed to air for 30 minutes at RT.

The scratch-resistant lacquer AS 4000® was then applied to the primer layer by flooding, and the substrate was exposed to air for 30 minutes at RT and then tempered for 60 minutes at 130° C.

Compared with the substrate, the following properties were determined:

| | Example 2 | Example 12 |
|---|---|---|
| Haze (%) | 0.59 | 0.28 |
| ΔHaze 100 (%) | 31.01 | 4.45 |
| ΔHaze 1000 (%) | 40.81 | 6.99 |
| Steel wool test Rakso 00 | considerable scratching | no scratching |
| Pencil hardness PH | 3B | 2H |
| Transmission % (550 nm) | 88.5 | 89.6 |
| Transmission % (700 nm) | 90.3 | 91.3 |
| Layer thickness (μm) | — | 2.8-5.8 μm |
| Adhesion (boiling test) | — | 4 h: 0 |

### Example 13

### Coating of the Test Rods of Example 4 on Both Sides with SHP 401®/AS 4000® (Dipping)

Coating on both sides was carried out by dipping test rods from Example 4 having a thickness of 2.2 mm in the lacquer solution. The rods were then exposed to air for 30 minutes at RT and then tempered for 60 minutes at 130° C.

The behaviour in fire was tested according to the UL standard described above. The following table shows the results.

### Behaviour in Fire:

| | Number | Number | Number | Number |
|---|---|---|---|---|
| UL 94 @ 2.2 mm | V-0 | V-1 | V-2 | V n.B. |
| Example 4 | 0 | 0 | 10 | 0 |
| Example 13 | 10 | 0 | 0 | 0 |

### Example 14

### Coating of the Sheet of Example 3 on One Side with UV HC 3000 (Flooding)

Example 3 is a substrate of a readily flowing polycarbonate having an MVR of 36 cm³/10 min.

The substrate was coated by flooding at an angle of 90°, exposed to air for 10 minutes at RT under a hood and then tempered for 10 minutes at 75° C.

UV crosslinking was then carried out under a CO₂ atmosphere with an Fe lamp, a UV dose of about 10 J/cm² being applied.

Compared with the substrate, the following property changes were achieved by the coating:

| | Example 3 | Example 14 |
|---|---|---|
| Haze (%) | 0.65 | 0.58 |
| ΔHaze 100 (%) | 34.0 | 3.2 |
| ΔHaze 1000 (%) | 40.9 | 6.1 |
| Steel wool test Rakso 00 | considerable scratching | no scratching |
| Pencil hardness PH | 3B | F |
| Transmission % (550 nm) | 90.0 | 90.7 |
| Transmission % (700 nm) | 90.1 | 91.7 |
| Layer thickness (μm) | — | 4.7-14.5 μm |
| Adhesion (boiling test) | — | 4 h: 0 |

### Example 15

### Coating of the Substrate Sheet of Example 3 on Both Sides with UV HC 3000® (Dipping)

The substrate sheet, cut to a size of 104×147×3 mm, was dipped in the lacquer solution for about one second. It is exposed to air for 10 minutes at RT under a hood and then tempered for 10 minutes at 75 C.

UV crosslinking was then carried out under a CO₂ atmosphere with an Fe lamp, a UV dose of about 10 J/cm² being applied.

By means of the dipping process there was obtained on both sides a scratch-resistant layer comparable, in terms of mechanical properties (abrasion or ΔHaze values, steel wool test and pencil hardness), with the coating applied on one side by the flooding process (Example 14). It was possible to achieve a further increase in the transmission values by means of the two-sided coating:

| | |
|---|---|
| Transmission % (550 nm) | 91.4 |
| Transmission % (700 nm) | 92.7 |

As is clear, all the mechanical properties and, surprisingly, also the transmission properties are improved considerably by the coating in Examples 14) and 15) too.

### Example 16

### Coating of UL Test Rods of the Composition of Example 1 on Both Sides by Dipping in in UV HC 3000® Scratch-Resistant Lacquer

Coating of the test rods on both sides was carried out by dipping the test rods of Example 5 in UV HC 3000® scratch-resistant solution.

The solvent was then evaporated off as in Example 15, and UV crosslinking was carried out.

The behaviour in fire was studied according to the UL test standard as described above:

| | Number | Number | Number | Number |
|---|---|---|---|---|
| UL 94 @ 3.2 mm | V-0 | V-1 | V-2 | V n.B. |
| Example 5, uncoated | 1 | 0 | 9 | 0 |
| Example 16 | 8 | 2 | 0 | 0 |

Summary of the fire tests: It will be seen from the results that the behaviour of Example 5 in fire was improved considerably by the coating (Example 16).

Summary of the test as a whole: Both the mechanical surface properties (abrasion, pencil hardness) and the optical properties (haze and transmission) were improved considerably by the coating. In addition, marked improvements were also achieved in respect of behaviour in fire.

In the region of layer thicknesses above about 10 μm, the rainbow effects that are frequently to be observed in the case of lacquered surfaces could not be observed.

### Example 17

### Coating of the Sheet of Example 3 on One Side with KASI-PC Flex® (Flooding)

The substrate of Example 3 is a readily flowing polycarbonate having an MVR of 36 cm/10 min.

Coating was carried out analogously to Example 9.

Compared with the substrate, the following property changes were achieved by the coating:

| | Example 3 | Example 17 |
|---|---|---|
| Haze (%) | 0.65 | 0.41 |
| ΔHaze 100 (%) | 34.0 | 3.2 |
| ΔHaze 1000 (%) | 40.9 | 12.1 |
| Steel wool test Rakso 00 | considerable scratching | no scratching |
| Pencil hardness PH | 3B | F |
| Transmission % (550 nm) | 90.0 | 90.5 |
| Transmission % (700 nm) | 90.1 | 91.7 |
| Layer thickness (μm) | — | 4.8-12.2 μm |
| Adhesion (boiling test) | — | 4 h: 0 |

### Example 18

### Coating of the Substrate Sheet of Example 3 on Both Sides with KASI-PC Flex® (Dipping)

The substrate sheet, cut to a size of 104×147×3 mm, was dipped in the lacquer solution for about one second, exposed to air for about 30 minutes at RT and then tempered for 60 minutes at 110° C.

By means of the dipping process there was obtained on both sides a scratch-resistant layer comparable, in terms of mechanical properties (abrasion or ΔHaze values, steel wool test and pencil hardness), with the coating applied on one side by the flooding process (Example 17). It was possible to achieve a further increase in the transmission values by means of the two-sided coating:

| | |
|---|---|
| Transmission % (550 nm) | 91.3 |
| Transmission % (700 nm) | 93.7 |

As is clear, all the mechanical properties and, surprisingly, also the transmission properties are improved considerably by the coating in the case of Examples 17) and 18) too.

### Example 19

### Coating of Ul Test Rods of Example 5 on Both Sides by Dipping in KASI-PC Flex®

Coating of the test rods on both sides was carried out by dipping the test rods of Example 5 in KASI-PC Flex® scratch-resistant lacquer solution. The rods were then exposed to air for 30 minutes at RT and then tempered for 60 minutes at 110° C.

### Behaviour in Fire

| | Number | Number | Number | Number |
|---|---|---|---|---|
| UL 94 @ 3.2 mm | V-0 | V-1 | V-2 | V n.B. |
| Example 5 | 1 | 0 | 9 | 0 |
| Example 19 | 10 | 0 | 0 | 0 |

Summary of the fire tests: It will be seen from the results that the behaviour of Example 5 in fire was improved considerably by the coating.

Summary of the test as a whole: Both the mechanical surface properties (abrasion, pencil hardness) and the optical properties (haze and transmission) were improved considerably by the coating. In addition, marked improvements were also achieved in respect of behaviour in fire.

In the region of layer thicknesses above about 10 μm, the rainbow effects that are frequently to be observed in the case of lacquered surfaces could not be observed.

### Example 20

### Coating of the Substrate of Example 2 by the Polyelectrolyte Process

The sheet is subjected to the following dipping processes:
dipping in cationic polyelectrolyte bath
dipping in water bath
dipping in anionic polyelectrolyte bath (containing anionic nanoparticles)
dipping in water bath

After this dipping sequence, a so-called polyelectrolyte bilayer layer is obtained. A coating of a plurality of polyelectrolyte bilayer layers is accordingly obtained by repeating the sequence several times.

The following polyelectrolyte solutions were used:

for step a. cationic polyelectrolyte solution: PDADMAC 0.05% in borate buffer pH 9.0

6.25 g of polydiallyldimethylammonium hydrochloride (PDADMAC 40% in water, MW<100,000 g/mol, Aldrich) were dissolved in 5 litres of borate buffer at pH 9.0 (3.73 g of KCl, 3.09 g of boric acid in 5 litres of water, adjusted to pH 9.0 with NaOH).

for step b. anionic nanoparticle solution: Levasil® 300, 0.05% in borate buffer pH 9.0

8.33 g of Levasil 300 (SiO2 nanoparticles, 9 nm, 30% in water, HC Starck) were dissolved in 5 litres of borate buffer solution at pH 9.0 (3.73 g of KCl, 3.09 g of boric acid in 5 litres of water, adjusted to pH 9.0 with NaOH).

### Production of Twelve Bilayer Layers Based on PDADMAC/Levasil 300 on the Substrate of Example 2

a. Dipping in the Cationic PDADMAC Solution:

The sheet of Example 2, having a size of 150×100 mm, was dipped in a 1-litre glass beaker containing 750 ml of the cationic polyelectrolyte solution PDADMAC with a residence time of 5 minutes. The sheet was then dipped three times, in each case for one minute, in a glass beaker containing fresh demineralised water.

b. Dipping in the Anionic Silica Nanoparticle Solution

The substrate coated with the cationic solution was dipped in a 1-litre glass beaker containing 750 ml of the anionic nanoparticle solution Levasil 300 with a residence time of 5 minutes. The sheet was then dipped three times, in each case for one minute, in a glass beaker containing fresh demineralised water.

After carrying out steps a. and b., the first bilayer layer of PDADMAC/Levasil 300 coating was obtained.

Steps a. and b. were repeated a total of 11 times, a substrate having 12 PDADMAC/Levasil 300 bilayer layers ultimately being obtained.

The coated sheet was then tempered for 30 minutes at 130° C. in a warm-air drying cabinet.

### Example 21

### Combined Coating of Polyelectrolyte and Scratch-Resistant Layer

The coated sheet of Example 20 was then coated on one side, by a flooding process, with the scratch-resistant lacquer PHC 587® analogously to Example 6. A coated sheet having the following mechanical data was obtained:

Compared with the substrate, the following property changes were achieved by the coating:

| | Example 2 | Example 21 |
|---|---|---|
| Haze (%) | 0.59 | 0.31 |
| ΔHaze 100 (%) | 31.01 | 1.19 |
| ΔHaze 1000 (%) | 40.81 | 2.56 |
| Steel wool test Rakso 00 | considerable scratching | no scratching |
| Pencil hardness PH | 3B | F |
| Transmission % (550 nm) | 88.5 | 94.0 |
| Transmission % (700 nm) | 90.3 | 95.6 |
| Layer thickness (μm) | — | 2.9-5.9 μm |
| Adhesion (boiling test) | — | 4 h: 0 |

### Example 22

### Coating of UL Test Rods (Example 4) on Both Sides with Polyelectrolyte Layers and Scratch-Resistant Layer

### Example 22a

UL test rods from Example 4 having a thickness of 2.6 mm were first coated analogously to Example 20 with a total of twelve PDADMAC/Levasil 300 bilayer layers.

### Example 22b

The test rods were then coated on both sides analogously to Example 8 by dipping the test rods in PHC 587® scratch-resistant lacquer solution. The rods were then exposed to air for 30 minutes at RT and then tempered for 60 minutes at 130° C.

The behaviour in fire was tested by means of the UL standard:

| | Number | Number | Number | Number |
|---|---|---|---|---|
| UL 94 @ 2.6 mm | V-0 | V-1 | V-2 | V n.B. |
| UL test rods | 0 | 0 | 10 | 0 |
| Example 22 a) | | | | |
| UL test rods | 8 | 2 | 0 | 0 |
| Example 22 b) | | | | |

Summary of the test as a whole: Both the mechanical surface properties (abrasion, pencil hardness) and the optical properties (haze and transmission) were improved considerably by the combined coating with the polyelectrolyte layer and the scratch-resistant layer. In addition, marked improvements were also achieved in respect of behaviour in fire.

1-15. (canceled)

16. A coated article comprising:
a) a substrate (S) having a transmission>75% (measured according to ASTM E 1348 at a layer thickness of 3 mm and a wavelength of 550 nm) and comprising a substrate layer of a thermoplastic plastic containing a flameproofing agent, and
b) a silica-containing scratch-resistant coating (K) on one side or on both sides of the substrate.

17. The coated article according to claim 16, further comprising c) polyelectrolyte (multi)layers (P) on one side or on both sides of the substrate.

18. The coated article according to claim 16, wherein the substrate (S) has a transmission>80%.

19. The coated article according to claim 16, wherein the substrate (S) has a transmission>85%.

20. The coated article according to claim 16, wherein the substrate is a polycarbonate or a polycarbonate mixture having an MVR greater than or equal to 10 (at 300° C. and 1.2 kg according to ISO 1133).

21. The coated article according to claim 19, wherein the substrate is a polycarbonate or a polycarbonate mixture having an MVR greater than or equal to 20.

22. The coated article according to claim 19, wherein the substrate is a polycarbonate or a polycarbonate mixture having an MVR greater than or equal to 30.

23. The coated article according to claim 16, wherein the flameproofing agent is selected from at least one from the group of the alkali and alkaline earth salts of aliphatic and aromatic sulfonic acid, sulfonamide and sulfonimide derivatives and phosphorus-containing flameproofing agents.

24. The coated article according to claim 16, wherein the flameproofing agent is selected from at least one from the group consisting of potassium nona-fluoro-1-butanesulfonate and sodium and potassium diphenylsulfonesulfonate.

25. The coated article according to claim 17, wherein one or more polyelectrolyte layers have been applied to the substrate.

26. The coated article according to claim 16, wherein the substrate (S) is a sheet, plate or film.

27. The coated article according to claim 16, wherein the silica-containing scratch-resistant coating is a coating obtainable from a thermally curable hybrid lacquer.

28. The coated article according to claim 16, wherein it has a transmission, measured according to ASTM E 1348, of at least 88% at a wavelength of 550 nm, a transmission, measured according to ASTM E 1348, of at least 90% at a wavelength of 700 nm, and values of less than 15% haze in the abrasion test, measured according to DIN 53 754, and achieves a rating of V1 or better with a probability of 70% in the flame resistance test according to standard UL 94V.

29. A process for the production of a coated article according to claim 16, comprising:
producing the substrate layer, and
coating on one side or on both sides with a silica-containing scratch-resistant coating.

30. A process according to claim 29, further comprising coating at least once with a polyelectrolyte layer.

31. Use of a coated article according to claim 16 in the production of flat display units or of glazing, in particular automotive or architectural glazing.

32. A flat display unit and glazing containing a coated article according to claim 16.
